(19) United States
(12) Patent Application Publication
(10) Pub. No.: US 2021/0086417 A1
(43) Pub. Date: Mar. 25, 2021

(54) INJECTION-MOLDING TOOL AND METHOD FOR MANUFACTURING AN INJECTION-MOLDED PRODUCT WITH A LONG, THIN CHANNEL

(71) Applicant: FOSTAG Formenbau AG, Stein am Rhein (CH)

(72) Inventor: Rolf MÜHLEMANN, Schlattingen (CH)

(73) Assignee: FOSTAG Formenbau AG, Stein am Rhein (CH)

(21) Appl. No.: 16/603,367

(22) PCT Filed: Apr. 4, 2018
(86) PCT No.: PCT/EP2018/058546

§ 371 Date: Oct. 7, 2019

(30) Foreign Application Priority Data
Apr. 7, 2017 (CH) 00470/17

(51) Int. Cl. B29C 45/26; B29C 45/36; B29C 45/44

(52) U.S. Cl. CPC B29C 45/261; B29L 2023/22; B29C 45/44; B29C 45/36

(57) ABSTRACT

An injection-molding tool has a cavity-forming die and a cavity-forming core pin, which form at least a part of a cavity, provision is made for the injection-molding tool to comprise at least one core-centering device for centering and supporting the core pin. The core-centering device comprises at least one retaining pin guided in a bore of the cavity-forming die. The retaining pin is in contact with the core pin by way of an end face in a retracted position and, in an extended position, is drawn back such that the end face does not project beyond an inner surface of the cavity-forming die, in which the bore ends.

### TECHNICAL FIELD

The invention relates to an injection-molding tool and a method for manufacturing injection-molded products with thin, long channels.

### TECHNICAL BACKGROUND

As a rule, injection-molding tools for manufacturing injection-molded products comprise a die retaining plate, which has at least one cavity-forming die, and a core retaining plate, which has at least one core unit with a cavity-forming core. The die here typically defines an outer surface of the injection-molded product. The core here typically defines an inner surface of the injection-molded product.

In order to manufacture injection-molded products having an elongated, thin channel, a correspondingly longer, thin core pin is required. However, the minimal diameter of the core pin—and hence the minimal diameter of the channel—is limited, because too thin a core pin is not rigid enough, and is pushed away from the central position in the die while injecting the plastic melt. This pushing away results in irregular wall thicknesses of the channel, up to including openings in the channel wall when the core pin is pressed against the die wall.

Therefore, it is virtually impossible to manufacture an injection-molded product with a thin, oblong channel, e.g., with a length of several centimeters and with an inner diameter of approx. 1 mm, without significant rejects.

### SUMMARY OF THE INVENTION

One aspect of the invention relates to an injection-molding tool and a method with which injection-molded products with oblong, thin channels can be manufactured.

In an embodiment, the injection-molding tool with a cavity-forming die and a cavity-forming core pin, which together form at least part of a cavity, comprise at least one core-centering arrangement for centering and protecting the core pin. The core-centering arrangement comprises at least one retaining pin guided in a bore of the cavity-forming die, which contacts the core pin with an end face in an extended position and is drawn back in a retracted position in such a way that the end face does not project beyond an inner surface of the cavity-forming die in which the bore ends.

The at least one retaining pin can prevent the core pin from being pushed away by having the retaining pin abut against the core pin and thereby support the latter in a centered position inside of the die. The manufacture of injection-molded products with long, thin channels is enabled by drawing the retaining pins into the retracted position or a partially retracted position before the injection molding process is over, in which the end face is spaced apart from the core pin and projects completely over the inner surface of the cavity-forming die. At this point in time, the cavity around the core pin is nearly completely filled. The still liquid melt fills the gaps created by extending the retaining pins, and the injection molding process is concluded. The injection-molded part can subsequently be demolded. If the retaining pin is still in the partially retracted position, it is drawn into the completely retracted position prior to demolding.

Preferred embodiments of the invention are also disclosed.

In several embodiments, the cavity-forming die in the area of the bore can be designed in such a way that the end face of the retaining pin closes flush with the cavity-forming surface of the die in an retracted position, so that no undercut arises on the injection-molded product or in the cavity-forming die in the demolding direction of the injection-molded product.

Due to the flush closure between the end face of the retaining pin and the surface of the cavity-binding die, there arises no undercut that would prevent or at least greatly hamper a demolding of the injection-molded products. This eliminates the need for the partially retracted position, and gives the tool a simpler design. If there were no flush closure of the end face, proceeding without a partially retracted position would either result in a depression in the die, or a portion of the pin would retract into the injection-molded product. Both of the above prevent an easy demolding of the injection-molded product.

In several embodiments, the end face can be shaped complementarily to a contact surface of the core pin, and the shape of the contact surface border can correspond to the shape of the bore border on the cavity-forming surface of the die.

In several embodiments, the retaining pin can have a front end with a concave recess to form the end face, and an inner radius of the retaining pin end face complementary to the outer radius of the core pin in the area of the contact surface. In other words, the end face has an inner radius that corresponds to the outer radius of the core pin, and can thus contact the core pin over the entire surface.

In several embodiments, the cavity-forming die can have a depression, preferably a groove aligned parallel to the core pin, the inner radius of which in the area of the bore corresponds to the outer radius of the core pin in the area of the contact surface.

In several embodiments, the injection-molding tool can have two core-centering arrangements, each with a retaining pin.

The retaining pins are preferably aligned coaxially and arranged diametrically in relation to the longitudinal axis of the core pin, so that the core pin is retained by two opposite sides. Any pushing away is now virtually impossible.

If the core pin is very long or very thin, several core-centering arrangements can be arranged one after the other in the longitudinal direction of the core pin, or the core-centering arrangement has two retaining pins, which are arranged one after the other in the longitudinal direction of the core pin.

In several embodiments, the retaining pin can be arranged so as to be displaceable at a right angle to the core pin.

In several embodiments, the core-centering arrangement can have a front stop for limiting the extended position of the retaining pin and/or a rear stop for limiting the retracted position of the retaining pin.

In several embodiments, the core-centering arrangement can have a sensor, preferably a contact sensor, which detects the retracted position of the retaining pin. This makes it possible to ensure that the tool will only be opened after all retaining pins have been completely retracted.

The core pin is typically conically shaped, so that it can be easily pulled out of the injection-molded product. The core pin can be retained at one or both ends with the tool closed.

The invention further relates to an injection-molded product with a channel formed by a core pin, manufactured with the injection-molding tool described above. The injection-molded product can have an oblong, preferably tubular, channel section, the exterior side of which has arranged on it a projection running in an axial direction of the channel section, e.g., in the form of a rib, wherein the outer radius of the projection corresponds to the inner radius of the channel section perpendicular to the longitudinal axis of the channel.

Depending on the positioning of the retaining pins, the ribs can vary in length. In an eccentric channel, e.g., if a channel section has two differing channels, the ribs/projections can be correspondingly arranged so as to be laterally displaced relative to the longitudinal axis.

The channel of the injection-molded product can be continuously designed with axial through holes on both sides, or can have one lateral through hole on one side.

The invention further relates to a method for manufacturing an injection-molded product with an oblong channel. The method involves the following steps: (a) Introducing a cavity-forming core pin into a cavity-forming die; (b) displacing at least one retaining pin into an extended position, so as to bring a contact surface of the core pin into contact with a complementary end face of the retaining pin; (c) injecting at least one plastic melt until at least one area of a cavity formed by the core pin and die is almost completely filled; (d) displacing the at least one retaining pin in a retracted position, in which the end face closes flush with an inner surface of the cavity-forming die, or a partially retracted position, in which the end face is spaced apart from the core pin and projects completely over the inner surface of the cavity-forming die; (e) concluding the injection of the at least one plastic melt until the cavity is completely filled; (f) if necessary, displacing the at least one retaining pin into a completely retracted position, in which the retaining pin is drawn back in such a way that the end face does not project beyond the inner surface of the cavity-forming die, provided the retaining pin was in the partially retracted position, and (g) demolding the injection-molded product.

### BRIEF DESCRIPTION OF THE DRAWINGS

The invention will be described in more detail below based on exemplary embodiments in conjunction with drawing(s) thereof. Shown in:

FIG. 1 is a perspective, partial view of an injection-molded product with an oblong channel section;

FIG. 2 is a sectional view along I-I through the channel section from FIG. 1;

FIG. 3 is a perspective, partial view of the injection-molded product from FIG. 1 and two retaining pins;

FIG. 4 is a sectional view along II-II from FIG. 3;

FIG. 5 is a sectional view through a channel section with two channels;

FIG. 6A is a sectional view of an injection-molded tool with centering arrangement, and FIG. 6B is a detailed view A from FIG. 6A;

FIG. 7A is a sectional view along III-III of the injection-molding tool from FIG. 6A, and FIG. 7B is a detailed view B from FIG. 7A; and

FIG. 8A is a partially cut, perspective view of the injection-molding tool from FIG. 6A, and FIG. 8B is a detailed view C from FIG. 8A.

### PREFERRED EMBODIMENTS OF THE INVENTION

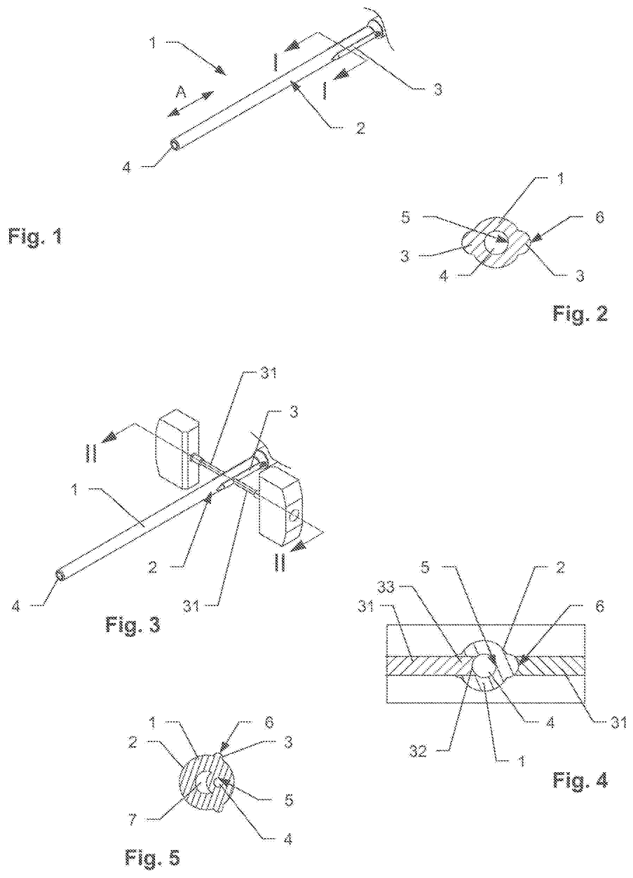

FIG. 1 shows a perspective, partial view of an injection-molded product with an oblong channel section 1. FIG. 2 shows a sectional view along I-I through the channel section from FIG. 1. FIG. 3 shows a perspective, partial view of the injection-molded product from FIG. 1, and two retaining pins 31 as arranged in the injection-molding tool relative to the injection-molded product. FIG. 4 shows a sectional view along II-II from FIG. 3.

In the embodiment shown, the channel section 1 forms a continuous channel 4 in an axial direction with through holes on both sides. An oblong rib 3 running in an axial direction of the channel 4 is molded on the exterior side 2 of the channel section, and its function will be described further below.

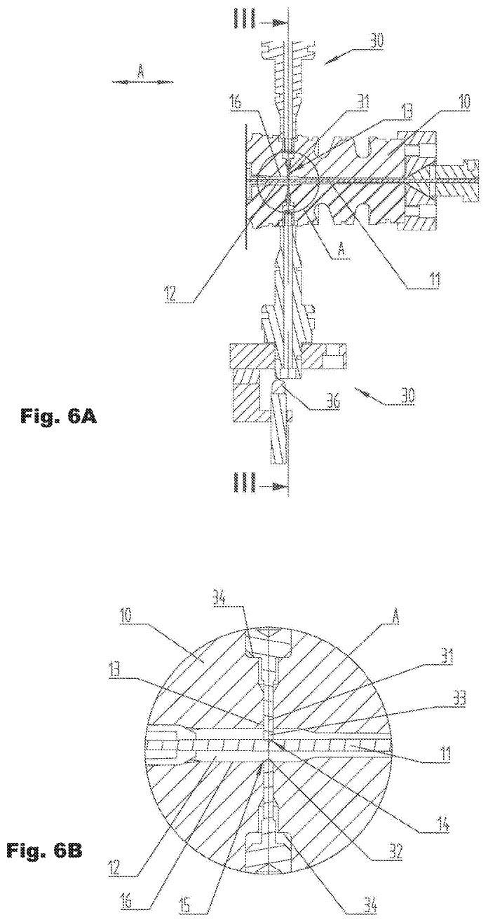

The channel 4 usually has a slightly conical shape with an inclination of approx. 2 degrees, so that a cavity-forming core pin 11 necessary for forming the channel 4 (e.g., see FIGS. 6A and 6B) can be easily pulled out in a demolding direction A. If possible, the core pin 11 is retained on both sides in the closed tool. If a channel that can be several centimeters long is to be fabricated with a small diameter, e.g., of approx. 1 mm, the core pin 11 is most often not rigid enough, and it can happen during the injection-molding process that the latter is pushed away from a central position. In order to prevent this pushing away, the injection-molding tool for manufacturing the injection-molded product with an oblong channel section 1 has two core-centering arrangements 30 (e.g., see FIGS. 6A and 6B), each with one retaining pin 31. FIGS. 3 and 4 depict the retaining pins 31 in the manner in which they are arranged relative to the injection-molded product in the injection-molding tool. The two retaining pins 31 are arranged in the area of the molded-on ribs 3. These ribs 3 are shaped in such a way as to not form any undercuts, and allow the plastic product to be easily demolded. Depending on the positioning of the retaining pins, they can be longer or shorter.

In order to fix the core pin 11 in the central position, the two retaining pins 31 are made to abut against the core pin in an extended position before injecting the plastic melt. Only once the cavity 12 (e.g., see FIGS. 6A and 6B) that forms the channel section 1 is nearly completely filled are the two retaining pins 31 moved into a retracted position, and the resultant gap in the injection-molded part is filled with the still liquid plastic melt. This process is schematically depicted on FIG. 4. The core pin 11 is shown in the extended position on the left side. The core pin 11 is shown in the retracted position on the right side.

In order for the two retaining pins 31 to fully abut against the core pin 11 in the extended position, their front ends 33 have a concavely shaped end face 32, which has an inner radius corresponding to the outer radius of the core pin 11 or the inner radius 5 of the channel 4.

In order to prevent the two retaining pins 31 from remaining immersed in the injection-molded product in the retracted position and also forming a depression in the cavity-forming die 10, the molded-on rib 3 has an outer radius 6 that also corresponds to the inner radius 5 of the channel 4 or outer radius of the core pin 11 or the inner radius of the end face 32. In this way, the end face 32 of the retaining pin 31 closes flush with the cavity-filming die. An immersion of the retaining pins 31 or a depression or undercut in the cavity wall is prevented.

FIG. 5 shows a sectional view through a channel section 1 with two channels. As opposed to the injection-molded product described above, two channels are formed here. A sickle-shaped channel 7 that is rigid enough owing to the sickle shape, and a circular, eccentrically arranged channel 4. The channel 4 is also formed by a thin core pin, which is supported on both sides by retaining pins. For this purpose, the channel section has two molded-on projections 3, the outer radius 6 of which also corresponds to the inner radius 5 of the channel 4. The two projections or ribs 3 are arranged offset to the midpoint of the channel section corresponding to the displacement direction of the retaining pins.

It would also be conceivable to form two circular channels, the core pins of which are each fixed in place with retaining pins.

FIGS. 6A and 6B show a sectional view of a cutout or parts of an injection-molding tool with two core-centering arrangements 30 in FIG. 6A and a detailed view from FIG. 6A (a) in FIG. 6B. A cavity-forming die 11 and the cavity-forming core pin 11 form the cavity 12 for the channel section 1 of the injection-molded product. A depression or groove 16 is formed in the cavity-forming die 11, and comprises the projection or rib 3 of the channel section 1. Present in the cavity-forming die 11 for each core-centering arrangement is a bore 13 in which the respective retaining pin 31 is guided. In the core-centering arrangement 30 depicted at the top of FIG. 6A, the retaining pin 31 is in the extended position, and its end face 32 contacts the contact surface 14 of the core pin 11. In the core-centering arrangement 30 shown below, the retaining pin 31 is in the retracted position, and closes flush with the cavity-forming surface 15 of the die 10 that surrounds the bore 13.

The core-centering arrangement 30 further comprises a contact sensor 36, which detects whether the retaining pin 31 is in the retracted position. Only once the retaining pins 31 are in the retracted position can the injection-molding tool be opened, and the injection-molded product be demolded.

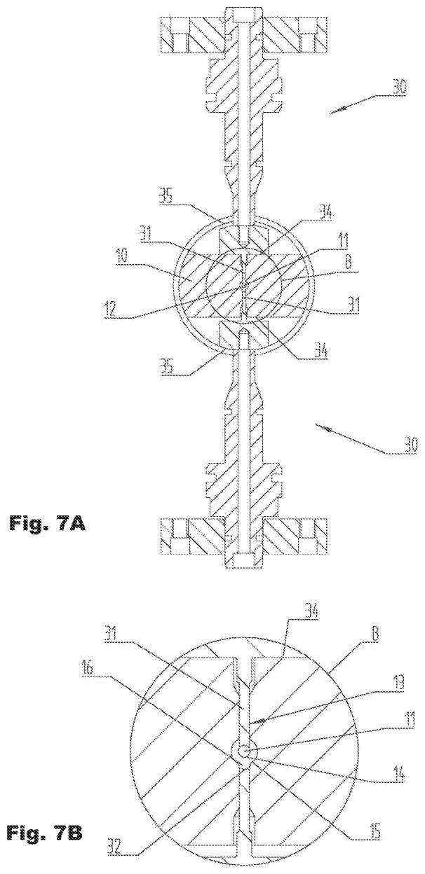

FIGS. 7A and 7B present a sectional view along III-III of the injection-molding tool from FIGS. 6A and 6B in FIG. 7A, and a detailed view B from FIG. 7A in FIG. 7B. Visible among other things in this illustration are a front stop 34 and a rear stop 35. These limit the maximum displacement of the retaining pins 31, so that the end face 32 of the latter abuts precisely against the core pin 11 in the extended position, and the end face 32 closes flush with the surface of the cavity-forming die 10 in the retracted position. In FIG. 7A, the retaining pin 31 above is in the extended position, and the retaining pin 31 below is in the retracted position.

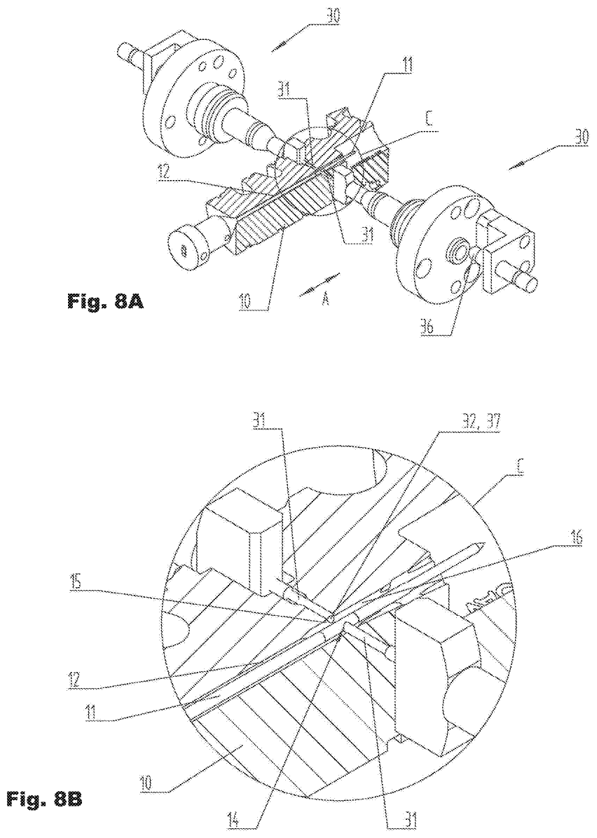

FIGS. 8A and 8B present a partially cut, perspective view of the injection-molding tool from FIGS. 6A and 6B in FIG. 8A, and a detailed view C from FIG. 8A in FIG. 8B. In FIG. 8A, the retaining pin 31 on the right is in the retracted position, and the retaining pin 31 on the left is in the extended position. As evident from this illustration, the end face 32 closes flush with the surface 15 of the cavity-forming die 10 that surrounds the bore 13. The end face 32 of the extended retaining pin 31 rests on the contact surface 14 of the core pin 11.

### REFERENCE LIST

1 Channel section
2 Exterior side of the channel section
3 Projection, rib
4 Channel
5 Inner radius of the channel
6 Outer radius of the projection
7 Sickle-shaped channel
10 Cavity-forming die
11 Cavity-forming core pin
12 Cavity
13 Bore
14 Contact surface
15 Cavity-forming surface
16 Depression, groove
30 Core-centering arrangement
31 Retaining pin
32 End face
33 Front end
34 Front Stop
35 Rear stop
36 (Contact) sensor
37 Concave recess
A Demolding direction

1-15. (canceled)

16. An injection-molding tool with a cavity-forming die and a cavity-forming core pin, which form at least part of a cavity, wherein the injection-molding tool comprises at least one core-centering arrangement for centering and supporting the core pin, wherein the core-centering arrangement comprises at least one retaining pin guided in a bore of the cavity-forming die, which contacts the core pin with an end face in an extended position and is drawn back in a retracted position in such a way that the end face does not project beyond an inner surface of the cavity-forming die in which the bore ends.

17. The injection-molding tool according to claim 16, wherein the cavity-forming die in the area of the bore is designed in such a way that the end face of the retaining pin closes flush with the cavity-forming surface of the die in the retracted position, so that no undercut arises on the injection-molded product or in the cavity-forming die in a demolding direction of the injection-molded product.

18. The injection-molding tool according to claim 16, wherein the end face is shaped complementarily to a contact surface of the core pin, and a shape of a contact surface border corresponds to a shape of a bore border on the cavity-forming surface of the die.

19. The injection-molding tool according to claim 16, wherein the retaining pin has a front end with a concave recess, and an inner radius of the retaining pin end face complementary to an outer radius of the core pin in the area of the contact surface.

20. The injection-molding tool according to claim 16, wherein the cavity-forming die has a depression aligned parallel to the core pin, an inner radius of which in the area of the bore corresponds to an outer radius of the core pin in the area of the contact surface.

21. The injection-molding tool according to claim 16, wherein the injection-molding tool has two core-centering arrangements, each with a retaining pin.

22. The injection-molding tool according to claim 21, wherein retaining pins are aligned coaxially and arranged diametrically in relation to a longitudinal axis of the core pin.

23. The injection-molding tool according to claim 16, wherein a plurality of core-centering arrangements are arranged one after the other in a longitudinal direction of the core pin.

24. The injection-molding tool according to claim 16, wherein the core-centering arrangement has two retaining pins, which are arranged one after the other in a longitudinal direction of the core pin.

25. The injection-molding tool according to claim 16, wherein the retaining pin is arranged so as to be displaceable at a right angle to the core pin.

26. The injection-molding tool according to claim 16, wherein the core-centering arrangement has a front stop for limiting the extended position of the retaining pin and/or wherein the core-centering arrangement has a rear stop for limiting the retracted position of the retaining pin.

27. The injection-molding tool according to claim 16, wherein the core-centering arrangement has a sensor which detects the retracted position of the retaining pin.

28. An injection-molded product with a channel formed by a core pin, manufactured with an injection-molding tool according to claim 16.

29. The injection-molded product according to claim 28, wherein the injection-molded product has an oblong, preferably tubular, channel section, an exterior side of which has arranged on it a projection running in an axial direction of the channel section, wherein an outer radius of the projection corresponds to an inner radius of the channel section perpendicular to the longitudinal axis of the channel.

30. A method for manufacturing an injection-molded product with an oblong channel, the method comprising:
introducing a cavity-forming core pin into a cavity-forming die;
displacing at least one retaining pin into an extended position, so as to bring a contact surface of the core pin into contact with a complementary end face of the retaining pin;
injecting at least one plastic melt until at least one area of a cavity formed by the core pin and the die is almost completely filled;
displacing the at least one retaining pin in a retracted position, in which the end face closes flush with an inner surface of the cavity-forming die, or a partially retracted position, in which the end face is spaced apart from the core pin and projects completely over the inner surface of the cavity-forming die;
concluding the injection of the at least one plastic melt until the cavity is completely filled;
if necessary, displacing the at least one retaining pin into a completely retracted position, in which the retaining pin is drawn back in such a way that the end face does not project beyond the inner surface of the cavity-forming die, provided the retaining pin was in the partially retracted position; and
demolding the injection-molded product.
